(19) United States
(12) Patent Application Publication
(10) Pub. No.: US 2025/0380344 A1
(43) Pub. Date: Dec. 11, 2025

(54) DRIVING CIRCUIT AND METHOD COMPATIBLE WITH SCR AND WIRELESS DIMMING, LAMP, AND SYSTEM

(71) Applicant: HANGZHOU TUYA INFORMATION TECHNOLOGY CO., LTD., Hangzhou, Zhejiang (CN)

(72) Inventors: Wenya GAO, Hangzhou (CN); Longfei WU, Hangzhou (CN); Shijie CHEN, Hangzhou (CN); Liwei SUN, Hangzhou (CN)

(73) Assignee: HANGZHOU TUYA INFORMATION TECHNOLOGY CO., LTD., Hangzhou, Zhejiang (CN)

(21) Appl. No.: 18/878,707

(22) PCT Filed: Jul. 15, 2022
(86) PCT No.: PCT/CN2022/106001

§ 371 Date: Dec. 24, 2024

(30) Foreign Application Priority Data
Jun. 24, 2022 (CN) 202210728882.8

(51) Int. Cl. H05B 45/10; H05B 45/325; H05B 45/34; H05B 45/37; H05B 47/115; H05B 47/19

(52) U.S. Cl. CPC H05B 45/10; H05B 45/325; H05B 45/34; H05B 45/37; H05B 47/115; H05B 47/19

(57) ABSTRACT

A driving circuit and method compatible with SCR and wireless dimming, a lamp, and a system. The driving circuit includes: an angle detection module connected with an SCR dimmer and configured to acquire conduction angle data of the SCR dimmer; a wireless control module connected with the angle detection module and configured to generate a control signal in response to a gesture operation adjustment instruction according to the conduction angle data of the SCR dimmer; and a power adjustment module connected with the SCR dimmer and the wireless control module and configured to acquire a power signal transmitted from the SCR dimmer and generate a driving signal according to the control signal. The scheme provided by the embodiments can accommodate the dimming needs of target users, achieving compatibility with both SCR and wireless dimming functions, improving dimming quality, and meeting the required dimming depth of the target users.

### TECHNICAL FIELD

The invention relates to the technical field of silicon-controlled rectifier (SCR) dimming, in particular to a driving circuit and method compatible with SCR and wireless dimming, a lamp, and a system.

### BACKGROUND

With the rise of LED lighting in recent years, replacing incandescent bulbs with LEDs has become a trend. While dedicated control chip technology that is compatible with SCRs has advanced quickly, issues like poor dimming quality and insufficient dimming depth still exist when using SCR dimmers for LED lighting.

### SUMMARY

The invention provides a driving circuit and method compatible with SCR and wireless dimming, a lamp, and a system, aimed at addressing issues like poor dimming quality and insufficient dimming depth when using SCR dimmers for LED lighting.

In one aspect of the invention, a driving circuit compatible with SCR and wireless dimming is provided, comprising:

an angle detection module connected with an SCR dimmer and configured to acquire conduction angle data of the SCR dimmer;

a wireless control module connected with the angle detection module and configured to generate a control signal in response to a gesture operation adjustment instruction according to the conduction angle data of the SCR dimmer; and

a power adjustment module connected with the SCR dimmer and the wireless control module and configured to acquire a power signal transmitted from the SCR dimmer and generate a driving signal according to the control signal.

Optionally, the conduction angle data comprises a first preset angle and a second preset angle;

the wireless control module is further configured to match the first preset angle of the conduction angle data with a first duty cycle of the control signal, and match the second preset angle of the conduction angle data with a second duty cycle of the control signal;

wherein the first preset angle is smaller than the second preset angle, and the first duty cycle of the control signal is smaller than the second duty cycle; a duty cycle of the control signal ranges between the first duty cycle and the second duty cycle; and the first preset angle is a conduction angle corresponding to a state when the SCR dimmer is adjusted to turn off an SCR lamp.

Optionally, the control signal comprises a first control signal, and the wireless control module is specifically configured to:

generate the first control signal in response to the gesture operation adjustment instruction when the conduction angle data of the SCR dimmer remain unchanged; wherein when a current conduction angle data of the SCR dimmer corresponds to a first target duty cycle of the control signal, a duty cycle of the first control signal ranges between the first duty cycle and the first target duty cycle; and the first target duty cycle is smaller than or equal to the second duty cycle;

the control signal comprises a second control signal, and the second control signal is generated when the conduction angle data of the SCR dimmer is adjusted from a first conduction angle to a second conduction angle; wherein the first conduction angle of the SCR dimmer corresponds to a second target duty cycle of the control signal, the second conduction angle of the SCR dimmer corresponds to a third target duty cycle of the control signal; and a duty cycle of the second control signal is adjusted back to the second target duty cycle from a current duty cycle first, and then adjusted to the third target duty cycle from the second target duty cycle.

Optionally, the wireless control module is specifically configured to:

match the first preset angle of the conduction angle data with the first duty cycle of the control signal, and match a current conduction angle data of the SCR dimmer with the second duty cycle of the control signal, when a duty cycle adjustment range of the SCR dimmer remains unchanged; wherein a second duty cycle of an actual output of the control signal is a product of the current conduction angle data of the SCR dimmer and a brightness ratio of the SCR lamp; and the brightness ratio of the SCR lamp is a ratio of the current conduction angle data of the SCR dimmer to a conduction angle corresponding to a maximum brightness of the SCR lamp.

Optionally, the driving circuit further comprises:

a passive bleeder circuit connected between the SCR dimmer and the angle detection module and configured to provide a remaining current for the SCR dimmer.

Optionally, the power adjustment module comprises:

a rectifier unit connected with the SCR dimmer and configured to rectify an AC power signal transmitted from the SCR dimmer into a DC power signal;

a DC-DC voltage stabilizer unit connected with the rectifier unit and configured to increase a voltage of the DC power signal and output a stable first power signal;

a DC-DC linear dimming unit connected with the DC-DC voltage stabilizer unit and an SCR lamp and configured to receive the first power signal and generate a driving signal according to the control signal; and

a modular power supply unit connected with the DC-DC voltage stabilizer unit and the wireless control module and configured to decrease a voltage of the first power signal and supply power to the wireless control module.

Optionally, a communication mode of the wireless control module supports communication comprises at least one of the following: WIFI, Zigbee, Bluetooth, and Thread.

In another aspect of the invention, a driving method compatible with SCR and wireless dimming is provided, comprising:

acquiring, by an angle detection module, conduction angle data of an SCR dimmer;

generating a control signal in response to a gesture operation adjustment instruction according to the conduction angle data of the SCR dimmer; and

outputting the control signal to a power adjustment module to adjust a driving signal output from the power adjustment module.

Optionally, before generating a control signal in response to a gesture operation adjustment instruction according to the conduction angle data of the SCR dimmer, the driving method further comprises:

matching a first preset angle of the conduction angle data with a first duty cycle of the control signal; and

matching a second preset angle of the conduction angle data with a second duty cycle of the control signal;

wherein the first preset angle is smaller than the second preset angle, the first duty cycle of the control signal is smaller than the second duty cycle, and a duty cycle of the control signal ranges between the first duty cycle and the second duty cycle.

Optionally, generating a control signal in response to a gesture operation adjustment instruction according to the conduction angle data of the SCR dimmer comprises:

matching the first preset angle of the conduction angle data with the first duty cycle of the control signal, and matching the second preset angle of the conduction angle data with the second duty cycle of the control signal;

the first preset angle is smaller than the second preset angle, and the first duty cycle of the control signal is smaller than the second duty cycle; a duty cycle of the control signal ranges between the first duty cycle and the second duty cycle; and the first preset angle is a conduction angle corresponding to a state when the SCR dimmer is adjusted to turn off an SCR lamp.

Optionally, generating a control signal in response to a gesture operation adjustment instruction according to the conduction angle data of the SCR dimmer further comprises:

generating a first control signal of the control signal in response to the gesture operation adjustment instruction when the conduction angle data of the SCR dimmer remain unchanged, wherein when a current conduction angle data of the SCR dimmer corresponds to a first target duty cycle of the control signal, a duty cycle of the first control signal ranges between the first duty cycle and the first target duty cycle, and the first target duty cycle is smaller than or equal to the second duty cycle;

generating a second control signal of the control signal when the conduction angle data of the SCR dimmer is adjusted from a first conduction angle to a second conduction angle, wherein the first conduction angle of the SCR dimmer corresponds to a second target duty cycle of the control signal, the second conduction angle of the SCR dimmer corresponds to a third target duty cycle of the control signal, and a duty cycle of the second control signal is adjusted back to the second target duty cycle from a current duty cycle first, and then adjusted to the third target duty cycle from the second target duty cycle; and

matching the first preset angle of the conduction angle data with the first duty cycle of the control signal, and matching the current conduction angle data of the SCR dimmer with the second duty cycle of the control signal, when a duty cycle adjustment range of the SCR dimmer remains unchanged, wherein a second duty cycle of an actual output of the control signal is a product of the current conduction angle data of the SCR dimmer and a brightness ratio of the SCR lamp, and the brightness ratio of the SCR lamp is a ratio of the current conduction angle data of the SCR dimmer to a conduction angle corresponding to a maximum brightness of the SCR lamp.

In another aspect of the invention, an SCR lamp is provided, comprising the driving circuit compatible with SCR and wireless dimming as described in the first aspect, and a lamp bead;

the driving circuit compatible with SCR and wireless dimming is configured to execute the driving method compatible with SCR and wireless dimming as described in the second aspect; and

the driving circuit compatible with SCR and wireless dimming is connected with the lamp bead and configured to output a driving signal to the lamp bead.

In another aspect of the invention, an SCR lamp control system is provided, comprising the SCR lamp as described in the third aspect, an SCR dimmer and an intelligent terminal;

the SCR lamp comprises the driving circuit compatible with SCR and wireless dimming as described in the first aspect;

the driving circuit compatible with SCR and wireless dimming of the SCR lamp establishes wireless communication with the intelligent terminal through a wireless control module; and the intelligent terminal is configured to synchronize a control signal output from the wireless control module and display a duty cycle adjustment range of the control signals.

The technical scheme of the embodiment of the invention is implemented in a circuit with an SCR dimmer, compatible with a wireless dimming module. It allows for brightness adjustment of the lamp bead through gesture operations performed on a mobile terminal. By responding to the gesture operations of a target user on the mobile terminal, the wireless control module receives the conduction angle data of the SCR dimmer and generates the control signal based on the conduction angle data. This ensures that the control signal is well compatible with the conduction angle data of the SCR dimmer while also accommodating the dimming needs of the target user, achieving compatibility with both SCR and wireless dimming functions, improving dimming quality, and meeting the required dimming depth of the target users.

It should be understood that what is described in this section is not intended to identify key or important features of embodiments of the invention, nor is it intended to limit the scope of the invention. Other features of the invention will be readily understood from the following description.

### BRIEF DESCRIPTION OF THE DRAWINGS

In order to explain the technical solution in the embodiments of the present invention more clearly, the drawings used in the embodiments will be briefly introduced below. Obviously, the drawings in the following description are only some embodiments of the present invention, and for those of ordinary skill in the art, other drawings can be obtained according to these drawings without paying creative effort.

FIG. 1 is a structural diagram of a driving circuit compatible with SCR and wireless dimming according to an embodiment of the invention;

FIG. 1a is a structural diagram of an SCR lamp control system according to an embodiment of the invention;

FIG. 2 is a schematic diagram of a relationship between a conduction angle of an SCR dimmer and a duty cycle of a control signal according to an embodiment of the invention;

FIG. 2a is a schematic diagram of an angle detection module detecting conduction angle data of an SCR dimmer according to an embodiment of the invention;

FIG. 3 is a schematic diagram of a brightness level bar on an intelligent terminal display interface according to an embodiment of the invention;

FIG. 4 is a schematic diagram of a relationship between an SCR conduction angle and a duty cycle adjustment range according to an embodiment of the invention;

FIG. 5 is a schematic diagram illustrating the variation of an SCR conduction angle in relation to a duty cycle of a control signal according to an embodiment of the invention;

FIG. 6 is a schematic diagram illustrating the variation of an SCR conduction angle in relation to a duty cycle of a control signal according to another embodiment of the invention;

FIG. 6a is a schematic diagram of a duty cycle adjustment range on an intelligent terminal display interface according to an embodiment of the invention;

FIG. 7 is a schematic diagram illustrating the variation of an SCR conduction angle in relation to a duty cycle adjustment range on an intelligent terminal display interface according to an embodiment of the invention;

FIG. 8 is a schematic diagram illustrating the variation of an SCR conduction angle in relation to a duty cycle adjustment range on an intelligent terminal display interface according to another embodiment of the invention;

FIG. 9 is a structural diagram of another driving circuit compatible with SCR and wireless dimming according to an embodiment of the invention;

FIG. 10 is a hardware topology architecture diagram of a driving power supply according to an embodiment of the invention;

FIG. 11 is a control flow chart of a driving method compatible with SCR and wireless dimming according to an embodiment of the invention;

FIG. 12 is a flowchart of another adjustment method compatible with SCR and wireless dimming according to an embodiment of the invention;

FIG. 13 is a flowchart of an adjustment method compatible with SCR and wireless dimming according to an embodiment of the invention;

FIG. 14 is a flowchart of yet another adjustment method compatible with SCR and wireless dimming according to an embodiment of the invention;

FIG. 14a is a flowchart of still another adjustment method compatible with SCR and wireless dimming according to an embodiment of the invention;

FIG. 15 is a structural diagram of an SCR lamp according to an embodiment of the invention; and

FIG. 16 is a structural diagram of an SCR lamp control system according to an embodiment of the invention.

### DETAILED DESCRIPTION OF EMBODIMENTS

For those skilled in the art to better understand the scheme of the invention, the technical scheme in the embodiments of the invention will be clearly and completely described below in combination with attached drawings. Obviously, the described embodiments are only part of the embodiments of the invention, not all of them. Based on the embodiments of the invention, all other embodiments obtained by those of ordinary skill in the art without paying creative effort shall belong to the scope of the invention.

It should be noted that the terms “first” and “second” in the specification and Claims of the invention and the drawings are used to distinguish similar objects, and are not necessarily used to describe a specific order or sequence. It should be understood that the data thus used are interchangeable under appropriate circumstances, so that the embodiments of the invention described herein can be implemented in other orders than those illustrated or described herein. Furthermore, the terms “comprise” and “have” and any variations thereof are intended to cover non-exclusive inclusion, for example, a process, method, system, product or device that comprises a series of steps or units is not necessarily limited to those explicitly listed, but may comprise other steps or units not explicitly listed or inherent to such process, method, product or device.

To facilitate the understanding of the technical scheme of the invention, the hardware architecture underlying the embodiment of the invention will be described first.

FIG. 1 is a structural diagram of a driving circuit compatible with SCR and wireless dimming according to an embodiment of the invention. FIG. 1a is a structural diagram of an SCR lamp control system according to an embodiment of the invention. FIG. 1a exemplarily shows that a driving circuit 100 compatible with SCR and wireless dimming is arranged in an LED lamp. FIG. 1a exemplarily shows that an SCR lamp control system comprises a power supply, such as an AC power supply Vac, and an SCR dimmer 110 and an LED lamp are connected in series between a positive electrode L and a negative electrode N of the power supply.

With reference to FIG. 1 and FIG. 1a, the driving circuit 100 compatible with SCR and wireless dimming provided by the embodiment of the invention comprises: an angle detection module 120 connected with an SCR dimmer 110 and configured to acquire conduction angle data of the SCR dimmer 110; a wireless control module 140 connected with the angle detection module 120 and configured to generate a control signal in response to a gesture operation adjustment instruction according to the conduction angle data of the SCR dimmer 110; and a power adjustment module 130 connected with the SCR dimmer 110 and the wireless control module 140 and configured to acquire a power signal transmitted from the SCR dimmer 110 and generate a driving signal according to the control signal.

Specifically, the angle detection module 120 is connected with the SCR dimmer and configured to detect the conduction angle data of the SCR dimmer 110, such as a current conduction angle and a historical conduction angle of the SCR dimmer 110. The angle detection module 120 sends the acquired conduction angle data of the SCR dimmer 110 to the wireless control module 140. The wireless control module 140 receives the conduction angle data. The wireless control module 140 may generate the control signal in response to the gesture operation adjustment instruction according to the conduction angle data. The control signal may comprise a PWM control signal or a pulse signal. The wireless control module 140 is connected with the power adjustment module 130. The wireless control module 140 sends the control signal to the power adjustment module 130. The power adjustment module 130 is connected with the SCR dimmer 110. The power adjustment module 130 adjusts the output driving signal according to the power signal output from the SCR dimmer 110 and the received control signal. The greater the driving signal, the higher the brightness of a lamp bead connected with the power adjustment module.

This arrangement facilitates compatibility with a wireless dimming module in a circuit with the SCR dimmer 110. It allows for brightness adjustment of the lamp bead through gesture operations performed on a mobile terminal. The mobile terminal may include devices such as smartphones, tablets, wearable devices, or remote controls. By responding to the gesture operations of a target user on the mobile terminal based on their specific requirements, the wireless control module 140 receives the conduction angle data of the SCR dimmer 110 and generates the control signal based on the conduction angle data. This ensures that the control signal is well compatible with the conduction angle data of the SCR dimmer 110 while also accommodating the dimming needs of the target user, achieving compatibility with both SCR and wireless dimming functions, improving dimming quality, and meeting the required dimming depth of the target users.

It should be noted that FIG. 1 exemplarily shows the case that the light bead includes an LED; as long as the light bead can adjust its brightness in response to changes in the driving signal, the type of the light bead is not restricted here.

According to the technical scheme of the embodiment of the invention, the angle detection module 120 is provided to acquire the conduction angle data of the SCR dimmer 110. By connecting the wireless control module 140 with the angle detection module 120, the wireless control module 140 generates the control signal in response to the gesture operation adjustment instruction according to the conduction angle data of the SCR dimmer 110. The power signal transmitted from the SCR dimmer 110 is acquired through the power adjustment module 130, and the driving signal is generated according to the control signal. This arrangement enables the driving signal to be well compatible with the conduction angle data of the SCR dimmer 110 and the dimming needs of the target user, achieving compatibility with both SCR and wireless dimming functions, improving dimming quality, and meeting the required dimming depth of the target users.

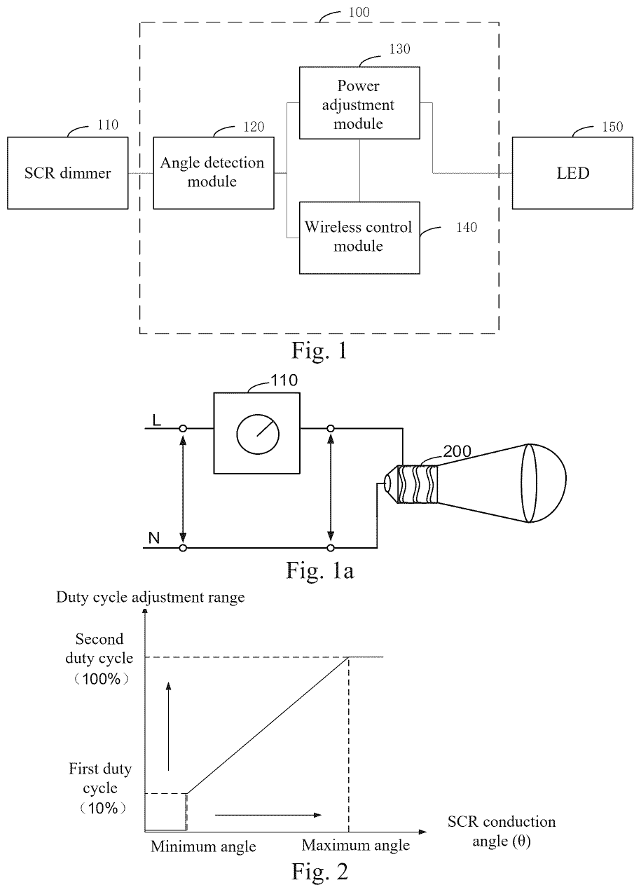

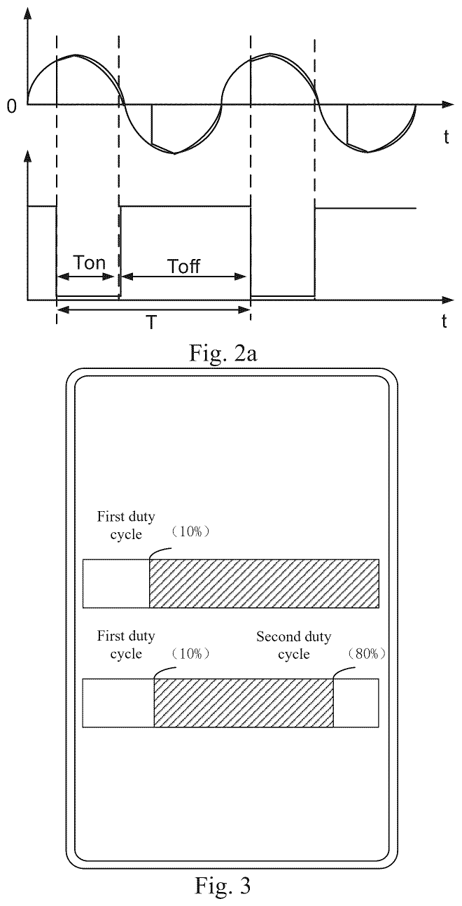

Optionally, FIG. 2 is a schematic diagram of a relationship between a conduction angle of an SCR dimmer and a duty cycle of a control signal according to an embodiment of the invention. FIG. 2a is a schematic diagram of an angle detection module detecting conduction angle data of an SCR dimmer according to an embodiment of the invention. On the basis of the above embodiment, combined with FIGS. 1-2a, the conduction angle data comprises a first preset angle and a second preset angle; the wireless control module is further configured to match the first preset angle of the conduction angle data with a first duty cycle of the control signal, and match the second preset angle of the conduction angle data with a second duty cycle of the control signal; the first preset angle is smaller than the second preset angle, and the first duty cycle of the control signal is smaller than the second duty cycle; a duty cycle of the control signal ranges between the first duty cycle and the second duty cycle; and the first preset angle is a conduction angle corresponding to a state when an SCR lamp is turned off.

Specifically, referring to FIG. 2a, the angle detection module 120 may generate conduction angle data corresponding to the power signal by collecting a phase angle of the power signal flowing through the SCR dimmer. The conduction angle data output from the angle detection module 120 are a pulse width signal. After receiving the conduction angle data, the wireless control module 140 acquires information about an AC zero-crossing point and a conduction angle by detecting the ratio of the conduction time width Ton to the non-conduction time Toff within one cycle of the pulse width signal or by detecting the rising and falling edges within the cycle.

The first preset angle and the second preset angle are respectively a minimum conduction angle and a maximum conduction angle of the SCR dimmer. It should be noted that the first preset angle is the maximum conduction angle when the SCR lamp is turned off. As shown in FIG. 2, there is a corresponding relationship between the conduction angle of the SCR dimmer and the PWM duty cycle of the output. A duty cycle corresponding to the first preset angle is called the first duty cycle, and a duty cycle corresponding to the second preset angle is called the second duty cycle.

A duty cycle of the control signal ranges between the first duty cycle and the second duty cycle. This arrangement enables the wireless control module to regulate the brightness within the adjustable range between the minimum and maximum brightness of the lamp bead.

FIG. 3 is a schematic diagram of a brightness level bar on an intelligent terminal display interface according to an embodiment of the invention. As shown in FIG. 3, the target user may set the first duty cycle and the second duty cycle of the SCR dimmer 110 through a display interface of the intelligent terminal. The conduction angle of the SCR dimmer 110 is between the first preset angle and the second preset angle, and the target user may adjust the duty cycle of the control signal within a range that falls between the first duty cycle and the second duty cycle.

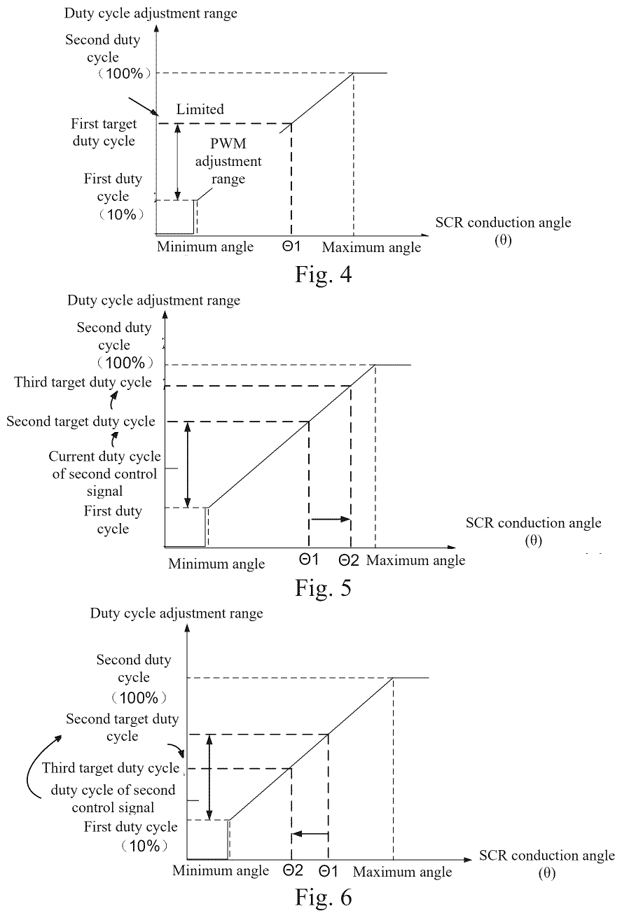

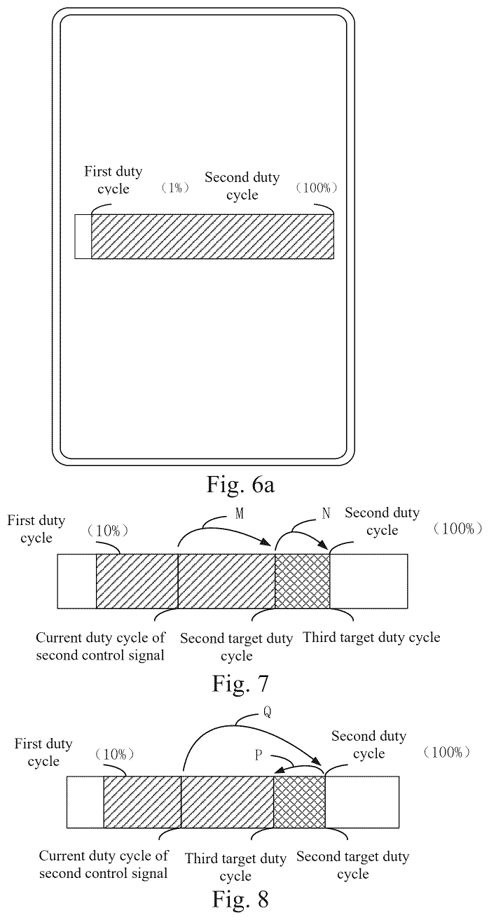

Optionally, FIG. 4 is a schematic diagram of a relationship between an SCR conduction angle and a duty cycle adjustment range according to an embodiment of the invention. FIG. 5 is a schematic diagram illustrating the variation of an SCR conduction angle in relation to a duty cycle of a control signal according to an embodiment of the invention. FIG. 6 is a schematic diagram illustrating the variation of an SCR conduction angle in relation to a duty cycle of a control signal according to another embodiment of the invention. On the basis of the above embodiment, with reference to FIGS. 1-4, the wireless control module is specifically configured to generate a first control signal in response to the gesture operation adjustment instruction when the conduction angle data of the SCR dimmer 110 remain unchanged. The control signal comprises the first control signal, and when a current conduction angle data of the SCR dimmer 110 correspond to a first target duty cycle of the control signal, the duty cycle of the first control signal ranges between the first duty cycle and the first target duty cycle; and the first target duty cycle is smaller than or equal to the second duty cycle.

A second control signal is generated when the conduction angle data of the SCR dimmer 110 is adjusted from a first conduction angle to a second conduction angle. The control signal comprises the second control signal, the first conduction angle of the SCR dimmer 110 corresponds to a second target duty cycle of the control signal, and the second conduction angle of the SCR dimmer 110 corresponds to a third target duty cycle of the control signal; and a duty cycle of the second control signal is adjusted back to the second target duty cycle from a current duty cycle first, and then adjusted to the third target duty cycle from the second target duty cycle.

Specifically, in an optional application scenario, the target user does not adjust the SCR lamp by operating the SCR dimmer 110, but adjusts the SCR lamp through the intelligent terminal. Referring to FIG. 4, when the conduction angle of the SCR dimmer 110 is fixed at a certain value between the first preset angle and the second preset angle, such as a first angle θ1 in FIG. 4, a duty cycle corresponding to the current conduction angle of the SCR dimmer 110 is the first target duty cycle. It should be noted that the first target duty cycle is between the first duty cycle and the second duty cycle, and the first target duty cycle is smaller than or equal to the second duty cycle. When the target user makes adjustment through the intelligent terminal, the device generates the first control signal in response to an operation instruction of the target user. A duty cycle corresponding to the first control signal is between the first duty cycle and the first target duty cycle.

In another optional application scenario, the target user adjusts the SCR lamp through the intelligent terminal, so that the brightness of the lamp corresponds to the current duty cycle. Then, the target user does not adjust the SCR lamp through the intelligent terminal, and the target user adjusts the SCR lamp by operating the SCR dimmer 110. Referring to FIGS. 5 and 6, when the conduction angle of the SCR dimmer 110 is adjusted from the current angle to another conduction angle, for example, the current conduction angle of the SCR dimmer 110 is a first conduction angle θ1, the target conduction angle of the SCR dimmer 110 is a second conduction angle θ2, a duty cycle of the control signal corresponding to the first conduction angle θ1 is the second target duty cycle, and a duty cycle of the control signal corresponding to the second conduction angle θ2 is the third target duty cycle. A second control signal is generated when the target user adjusts the brightness of the SCR lamp through the SCR dimmer 110. The duty cycle of the second control signal is gradually adjusted back to the second target duty cycle from the current duty cycle, and then gradually adjusted from the second target duty cycle to the third target duty cycle. Due to the existence of the wireless adjustment module 140, the current duty cycle of the second control signal may not be equal to the second target duty cycle.

It should be noted that FIG. 5 exemplarily shows that the third target duty cycle is greater than the second target duty cycle, and the second target duty cycle is greater than the current duty cycle of the second control signal. When the angle of the SCR dimmer 110 is adjusted from the first conduction angle θ1 to the second conduction angle θ2, the duty cycle corresponding to the second control signal is first adjusted to the second target duty cycle from the current duty cycle smaller than the second target duty cycle, and then adjusted to the third target duty cycle from the second target duty cycle.

FIG. 6 exemplarily shows that the third target duty cycle is smaller than the second target duty cycle, and the second target duty cycle is greater than the current duty cycle of the second control signal. When the angle of the SCR dimmer 110 is adjusted from the first conduction angle θ1 to the second conduction angle θ2, the duty cycle corresponding to the second control signal is first adjusted to the second target duty cycle from the current duty cycle smaller than the second target duty cycle, and then adjusted to the third target duty cycle from the second target duty cycle.

In yet another optional application scenario, FIG. 6a is a schematic diagram of a duty cycle adjustment range on an intelligent terminal display interface according to an embodiment of the invention. When a duty cycle adjustment range of the intelligent terminal remains unchanged, the first preset angle of the conduction angle data is matched with the first duty cycle of the control signal, and the current conduction angle data of the SCR dimmer are matched with the second duty cycle of the control signal; a second duty cycle of an actual output of the control signal is a product of the current conduction angle data of the SCR dimmer and a brightness ratio of the SCR lamp; and the brightness ratio of the SCR lamp is a ratio of the current conduction angle data of the SCR dimmer to a conduction angle corresponding to a maximum brightness of the SCR lamp.

Specifically, when the duty cycle displayed on the intelligent terminal remains unchanged, for example, the duty cycle adjustment range of the SCR lamp displayed on the intelligent terminal is 1%-100%, a second duty cycle of an actual output of the control signal is a product of the current conduction angle data of the SCR dimmer and a brightness ratio of the SCR lamp. The brightness ratio of the SCR lamp is a ratio of the current conduction angle data of the SCR dimmer to a conduction angle corresponding to a maximum brightness of the SCR lamp. When the target user adjusts the conduction angle of the SCR dimmer from 60° to 80°, the duty cycle adjustment range of the SCR lamp displayed on the intelligent terminal is still 1%-100%. When the target user sets the conduction angle of the SCR dimmer to 60°, the duty cycle 100% of the SCR lamp displayed on the intelligent terminal corresponds to a maximum brightness of the SCR lamp at the conduction angle of 60°. When the target user sets the conduction angle of the SCR dimmer to 80°, the duty cycle 100% of the SCR lamp displayed on the intelligent terminal corresponds to a maximum brightness of the SCR lamp at the conduction angle of 80°. FIG. 7 is a schematic diagram illustrating the variation of an

SCR conduction angle in relation to a duty cycle adjustment range on an intelligent terminal display interface according to an embodiment of the invention. FIG. 8 is a schematic diagram illustrating the variation of an SCR conduction angle in relation to a duty cycle adjustment range on an intelligent terminal display interface according to another embodiment of the invention. The duty cycle adjustment range on the intelligent terminal of the target user changes with the SCR conduction angle range.

Referring to FIG. 7, for example, in the case that the third target duty cycle is greater than the second target duty cycle and the second target duty cycle is greater than the current duty cycle of the second control signal, the duty cycle corresponding to the second control signal is first adjusted from the current duty cycle to the second target duty cycle (adjustment step M), and then the duty cycle corresponding to the second control signal is adjusted from the second target duty cycle to the third target duty cycle (adjustment step N). When the conduction angle of the SCR dimmer 110 changes, the duty cycle adjustment range also changes.

Referring to FIG. 8, for example, in the case that the third target duty cycle is smaller than the second target duty cycle and the second target duty cycle is greater than the current duty cycle of the second control signal, the duty cycle corresponding to the second control signal is first adjusted from the current duty cycle to the second target duty cycle (adjustment step Q), and then the duty cycle corresponding to the second control signal is adjusted from the second target duty cycle to the third target duty cycle (adjustment step P). When the conduction angle of the SCR dimmer 110 changes, the duty cycle adjustment range also changes.

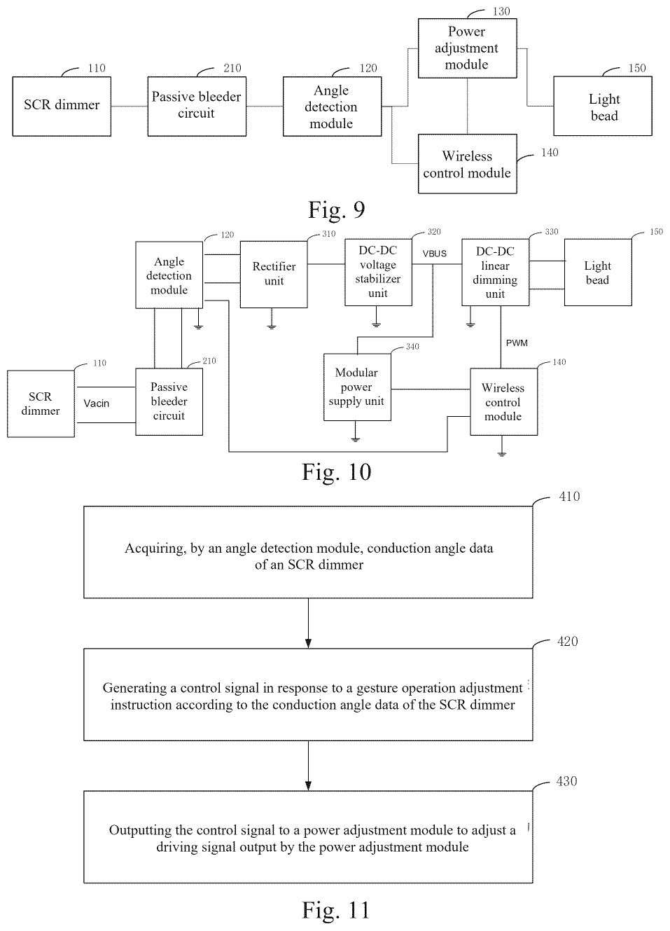

FIG. 9 is a structural diagram of another driving circuit compatible with SCR and wireless dimming according to an embodiment of the invention. This embodiment is an enhancement of the above embodiment. Referring to FIG. 9, the driving circuit compatible with SCR and wireless dimming also comprises a passive bleeder circuit 210. The driving circuit provided by the embodiment of the invention further comprises a passive bleeder circuit 210 connected between the SCR dimmer 110 and the angle detection module 120 and configured to provide a remaining current for the SCR dimmer 110.

Specifically, the passive bleeder circuit 210 is a capacitor-resistor series circuit, providing a remaining current for the normal operation of the SCR dimmer 110. The passive bleeder circuit 210 is arranged between the SCR dimmer 110 and the angle detection module 120, enabling the angle detection module 120 to better detect the conduction angle and AC zero-crossing point of the SCR dimmer 110.

FIG. 10 is a hardware topology architecture diagram of a driving power supply according to an embodiment of the invention. This embodiment optimizes the power adjustment module 130 on the basis of the above embodiment. The power adjustment module 130 comprises:

a rectifier unit 310 connected with the SCR dimmer 110 and configured to rectify an AC power signal transmitted from the SCR dimmer 110 into a DC power signal;

a DC-DC voltage stabilizer unit 320 connected with the rectifier unit 310 and configured to increase a voltage of the DC power signal and output a stable first power signal;

a DC-DC linear dimming unit 330 connected with the DC-DC voltage stabilizer unit 320 and an SCR lamp 150 and configured to receive the first power signal and generate a driving signal according to the control signal; and

a modular power supply unit 340 connected with the DC-DC voltage stabilizer unit 320 and the wireless control module 140 and configured to decrease a voltage of the first power signal and supply power to the wireless control module 140.

Specifically, as shown in FIG. 10, the driving circuit comprises the passive bleeder circuit 210, the angle detection module 120, the rectifier unit 310, the DC-DC voltage stabilizer unit 320, the DC-DC linear dimming unit 330, the LED 150, the modular power supply unit 340, and the wireless control module 140.

The angle detection module 120 is configured to detect the SCR conduction angle, the angle detection module 120 transmits the SCR conduction angle data to the wireless control module 140, and the wireless control module 140 receives the SCR conduction angle data for wireless dimming control.

The rectifier unit 310 is connected with the SCR dimmer 110, and rectifies a AC signal into a DC signal, which is then output to the DC-DC voltage stabilizer unit 320.

The DC-DC voltage stabilizer unit 320 is connected with the rectifier unit 330, and the DC-DC voltage stabilizer unit 320 increases a voltage of a rectified DC power signal and outputs a stable first power signal for the power supply of the DC-DC linear dimming unit 330 and the modular power supply unit 340.

The DC-DC linear dimming unit 330 is connected with the wireless control module 140 and the LED 150. The DC-DC linear dimming unit 330 receives the first power signal and the control signal of the wireless control module 140, and the signals received by the DC-DC linear dimming unit 330 are used to control the generation of driving signals.

The modular power supply unit 340 is connected with the DC-DC voltage stabilizer unit 320 and the wireless control module 140, and the modular power supply unit 340 steps down the first power signal and outputs it to the wireless control module 140.

The wireless control module 140 is connected with the DC-DC linear dimming unit 330, and processes an SCR conduction signal and a received control signal of the target user terminal and outputs them to the DC-DC linear dimming unit 330. It should be noted that a communication mode for receiving the control signal of the target user terminal includes at least one of WIFI, zigbee, Bluetooth and Thread.

FIG. 11 is a control flow chart of a driving method compatible with SCR and wireless dimming according to an embodiment of the invention. The method may be executed by a control device of the driving circuit compatible with SCR and wireless dimming provided by the embodiment of the invention, and the device may be realized by software and/or hardware. Referring to FIG. 11, the driving method compatible with SCR and wireless dimming comprises the following steps:

S410, acquiring, by an angle detection module, conduction angle data of an SCR dimmer;

S420, generating a control signal in response to a gesture operation adjustment instruction according to the conduction angle data of the SCR dimmer;

specifically, the gesture operation instruction is sent by the target user when making adjustment on the terminal, and is received by the wireless control module, and the control signal is generated by the wireless control module after receiving the conduction angle data of the SCR dimmer and the gesture operation instruction and processing them;

S430, outputting the control signal to a power adjustment module to adjust a driving signal output from the power adjustment module;

specifically, after receiving the control signal, the power adjustment module generates the corresponding driving signal according to the control signal.

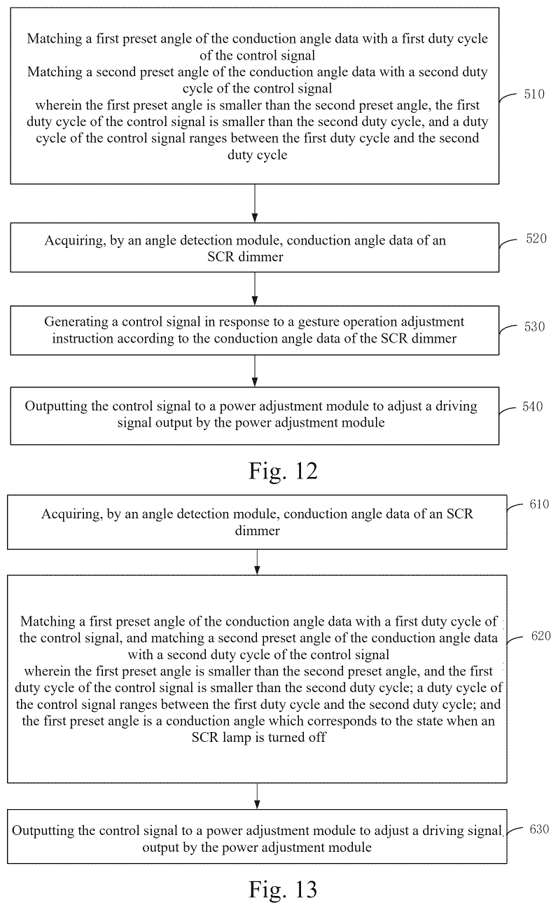

FIG. 12 is a flowchart of another adjustment method compatible with SCR and wireless dimming according to an embodiment of the invention. This embodiment is an enhancement of the above embodiment. Referring to FIG. 12, the adjustment method compatible with SCR and wireless dimming comprises the following steps:

S510, matching a first preset angle of the conduction angle data with a first duty cycle of the control signal, and matching a second preset angle of the conduction angle data with a second duty cycle of the control signal;

wherein the first preset angle is smaller than the second preset angle, the first duty cycle of the control signal is smaller than the second duty cycle, and a duty cycle of the control signal ranges between the first duty cycle and the second duty cycle;

S520, acquiring, by an angle detection module, conduction angle data of an SCR dimmer;

S530, generating a control signal in response to a gesture operation adjustment instruction according to the conduction angle data of the SCR dimmer;

S540, outputting the control signal to a power adjustment module to adjust a driving signal output from the power adjustment module.

FIG. 13 is a flowchart of an adjustment method compatible with SCR and wireless dimming according to an embodiment of the invention. Referring to FIG. 13, the adjustment method compatible with SCR and wireless dimming comprises the following steps:

S610, acquiring, by an angle detection module, conduction angle data of an SCR dimmer;

S620, matching a first preset angle of the conduction angle data with a first duty cycle of the control signal, and matching a second preset angle of the conduction angle data with a second duty cycle of the control signal;

wherein the first preset angle is smaller than the second preset angle, and the first duty cycle of the control signal is smaller than the second duty cycle; a duty cycle of the control signal ranges between the first duty cycle and the second duty cycle; and the first preset angle is a conduction angle corresponding to a state when an SCR lamp is turned off;

S630, outputting the control signal to a power adjustment module to adjust a driving signal output from the power adjustment module.

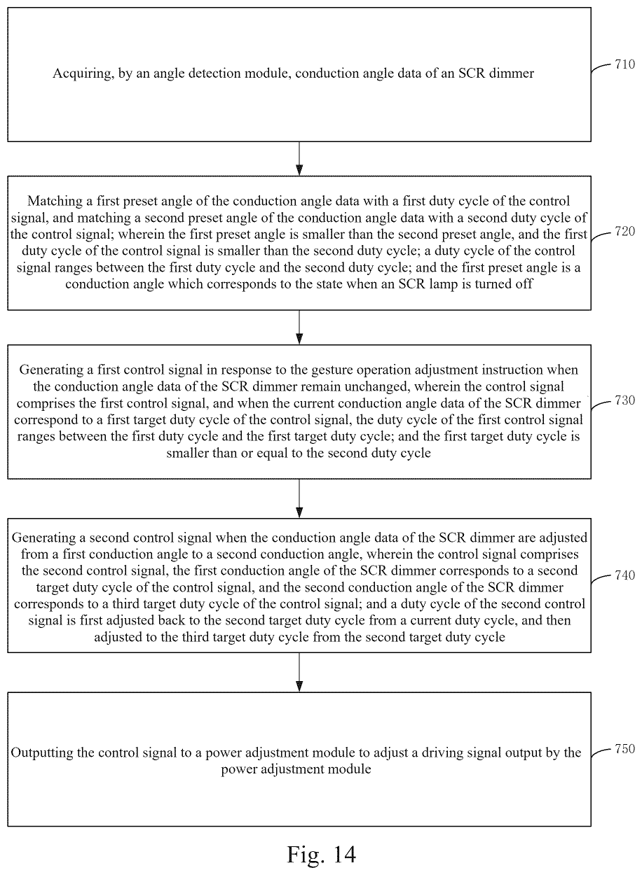

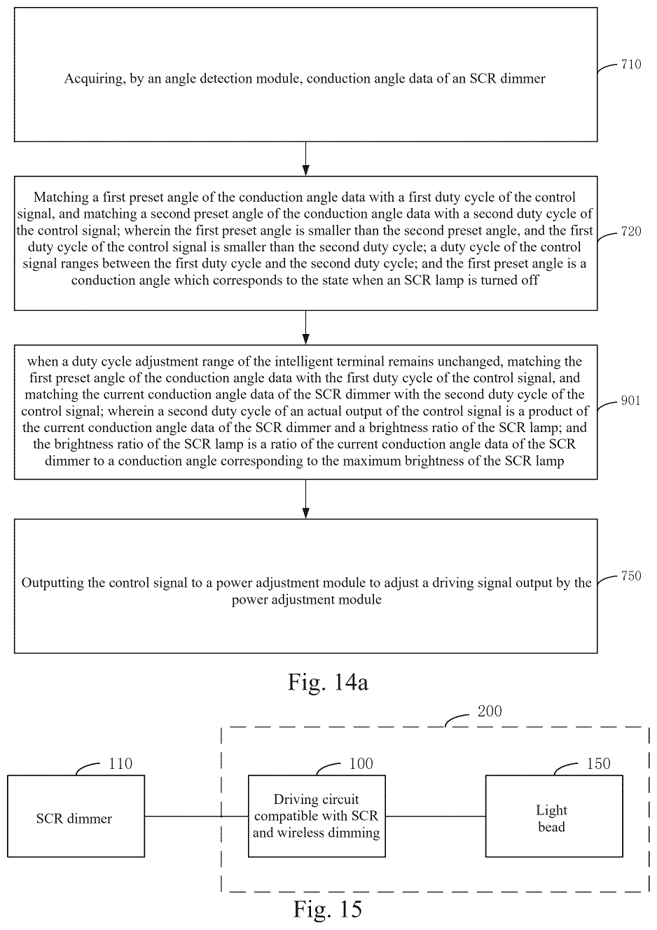

FIG. 14 is a flowchart of yet another adjustment method compatible with SCR and wireless dimming according to an embodiment of the invention. Referring to

FIG. 14, the adjustment method compatible with SCR and wireless dimming comprises the following steps:

S710, acquiring, by an angle detection module, conduction angle data of an SCR dimmer;

S720, matching a first preset angle of the conduction angle data with a first duty cycle of the control signal, and matching a second preset angle of the conduction angle data with a second duty cycle of the control signal;

wherein the first preset angle is smaller than the second preset angle, and the first duty cycle of the control signal is smaller than the second duty cycle; a duty cycle of the control signal ranges between the first duty cycle and the second duty cycle; and the first preset angle is a conduction angle corresponding to a state when an SCR lamp is turned off;

S730, generating a first control signal in response to a gesture operation adjustment instruction when the conduction angle data of the SCR dimmer remain unchanged;

wherein the control signal comprises the first control signal, and when a current conduction angle data of the SCR dimmer corresponds to a first target duty cycle of the control signal, the duty cycle of the first control signal ranges between the first duty cycle and the first target duty cycle; and the first target duty cycle is smaller than or equal to the second duty cycle;

S740, generating a second control signal when the conduction angle data of the SCR dimmer is adjusted from a first conduction angle to a second conduction angle;

wherein the control signal comprises the second control signal, the first conduction angle of the SCR dimmer corresponds to a second target duty cycle of the control signal, the second conduction angle of the SCR dimmer corresponds to a third target duty cycle of the control signal; and a duty cycle of the second control signal is adjusted back to the second target duty cycle from a current duty cycle first, and then adjusted to the third target duty cycle from the second target duty cycle;

S750, outputting the control signal to a power adjustment module to adjust a driving signal output from the power adjustment module.

FIG. 14a is a flowchart of still another adjustment method compatible with SCR and wireless dimming according to an embodiment of the invention. Referring to FIG. 14a, the adjustment method compatible with SCR and wireless dimming comprises the following steps:

S710, acquiring, by an angle detection module, conduction angle data of an SCR dimmer;

S720, matching a first preset angle of the conduction angle data with a first duty cycle of the control signal, and matching a second preset angle of the conduction angle data with a second duty cycle of the control signal;

wherein the first preset angle is smaller than the second preset angle, and the first duty cycle of the control signal is smaller than the second duty cycle; a duty cycle of the control signal ranges between the first duty cycle and the second duty cycle; and the first preset angle is a conduction angle corresponding to a state when an SCR lamp is turned off;

S901, when a duty cycle adjustment range of the intelligent terminal remains unchanged, matching the first preset angle of the conduction angle data with the first duty cycle of the control signal, and matching the current conduction angle data of the SCR dimmer with the second duty cycle of the control signal; wherein a second duty cycle of an actual output of the control signal is a product of the current conduction angle data of the SCR dimmer and a brightness ratio of the SCR lamp; and the brightness ratio of the SCR lamp is a ratio of the current conduction angle data of the SCR dimmer to a conduction angle corresponding to a maximum brightness of the SCR lamp;

S750, outputting the control signal to a power adjustment module to adjust a driving signal output from the power adjustment module. FIG. 15 is a structural diagram of an SCR lamp according to an embodiment of the invention. The SCR lamp 200 provided by the embodiment of the invention comprises the driving circuit 100 compatible with SCR and wireless dimming proposed by any of the above embodiments and the lamp bead 150. The driving circuit 100 compatible with SCR and wireless dimming is used to execute the driving method compatible with SCR and wireless dimming proposed in any of the above embodiments. The driving circuit 100 compatible with SCR and wireless dimming is connected with the lamp bead 150, and the driving circuit 100 compatible with SCR and wireless dimming is used to output the driving signal to the lamp bead 150.

Specifically, the SCR lamp 200 provided by the embodiment of the invention comprises the SCR dimmer 110, the driving circuit 100 compatible with SCR and wireless dimming, and the lamp bead 150, such as an LED. FIG. 15 exemplarily shows that the driving circuit 100 compatible with SCR and wireless dimming is connected with the SCR dimmer 110 and the LED, and is used to execute the driving method compatible with SCR and wireless dimming proposed in any of the above embodiments, and output the driving signal processed by this method to the lamp bead 150.

The SCR lamp provided by the embodiment of the invention comprises the driving circuit 100 compatible with SCR and wireless dimming, and has the beneficial effects of the driving circuit 100 compatible with SCR and wireless dimming proposed by any of the above embodiments, which will not be repeated here.

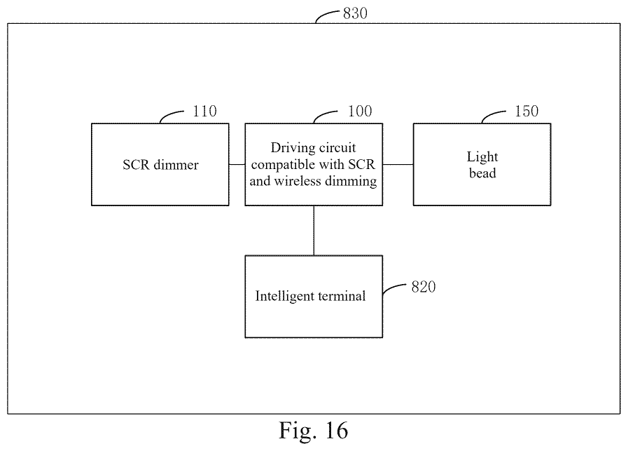

FIG. 16 is a structural diagram of an SCR lamp control system according to an embodiment of the invention. The SCR lamp control system provided by the invention comprises the SCR lamp 200 proposed in any of the above embodiments, the SCR dimmer 110 and an intelligent terminal 820. The SCR lamp 200 comprises the driving circuit 100 compatible with SCR and wireless dimming proposed in any of the above embodiments. The driving circuit 100 compatible with SCR and wireless dimming of the SCR lamp 200 establishes wireless communication with the intelligent terminal 820 through a wireless control module 140; and the intelligent terminal is configured to synchronize a control signal output from the wireless control module and display a duty cycle adjustment range of the control signals. The SCR lamp control system 830 comprises the SCR lamp 200 and the intelligent terminal 820, and the SCR lamp 200 comprises the SCR dimmer 110, the driving circuit 100 compatible with SCR and wireless dimming and the lamp bead 150 mentioned above.

Specifically, the target user sends a control signal to the driving circuit 100 compatible with SCR and wireless dimming through the intelligent terminal 820, and the driving circuit 100 compatible with SCR and wireless dimming receives the control signal of the intelligent terminal 820 through the wireless control module 140 and executes it.

In an optional application scenario, the target user adjusts the SCR lamp through the intelligent terminal, so that the brightness of the lamp corresponds to the current duty cycle. Then, the target user does not adjust the SCR lamp through the intelligent terminal, and the target user adjusts the SCR lamp by operating the SCR dimmer 110. When the conduction angle of the SCR dimmer 110 is adjusted from a current angle to another conduction angle, for example, the current conduction angle of the SCR dimmer 110 is a first conduction angle θ1, the target conduction angle of the SCR dimmer 110 is a second conduction angle θ2, a duty cycle of the control signal corresponding to the first conduction angle θ1 is the second target duty cycle, and a duty cycle of the control signal corresponding to the second conduction angle θ2 is the third target duty cycle. The intelligent terminal is configured to synchronize a control signal output from the wireless control module and display a duty cycle adjustment range of the control signals, which spans from the first target duty cycle to the third target duty cycle.

In another optional application scenario, when a duty cycle adjustment range of the intelligent terminal remains unchanged, the first preset angle of the conduction angle data is matched with the first duty cycle of the control signal, and the current conduction angle data of the SCR dimmer are matched with the second duty cycle of the control signal; a second duty cycle of an actual output of the control signal is a product of the current conduction angle data of the SCR dimmer and a brightness ratio of the SCR lamp; and the brightness ratio of the SCR lamp is a ratio of the current conduction angle data of the SCR dimmer to a conduction angle corresponding to a maximum brightness of the SCR lamp. The intelligent terminal is configured to synchronize a control signal output from the wireless control module and display a duty cycle adjustment range of the control signals, which spans from the first duty cycle to the second duty cycle.

The SCR lamp control system 830 provided by the invention comprises the SCR lamp 200 proposed in any of the above embodiments, and has the beneficial effects of the SCR lamp 200 proposed in any of the above embodiments, which will not be repeated here.

It should be understood that the various forms of processes shown above can be rearranged or subjected to step addition or deletion. For example, the steps described in this invention can be performed in parallel, sequentially, or in a different order, as long as the desired results of the technical scheme of the invention can be achieved, which is not limited here.

The above specific implementations do not limit the scope of the invention. It should be understood by those skilled in the art that various modifications, combinations, subcombinations and substitutions can be made according to design requirements and other factors. Any modification, equivalent substitution and improvement made within the spirit and principle of the invention should be included in the scope of the invention.

1-14. (canceled)

15. A driving circuit compatible with silicon-controlled rectifier (SCR) and wireless dimming, comprising:
an angle detection module connected with an SCR dimmer and configured to acquire conduction angle data of the SCR dimmer;
a wireless control module connected with the angle detection module and configured to generate a control signal in response to a gesture operation adjustment instruction according to the conduction angle data of the SCR dimmer; and
a power adjustment module connected with the SCR dimmer and the wireless control module and configured to acquire a power signal transmitted from the SCR dimmer and generate a driving signal according to the control signal.

16. The driving circuit according to claim 15, wherein the conduction angle data comprises a first preset angle and a second preset angle;
the wireless control module is further configured to match the first preset angle of the conduction angle data with a first duty cycle of the control signal, and match the second preset angle of the conduction angle data with a second duty cycle of the control signal;
wherein the first preset angle is smaller than the second preset angle, and the first duty cycle of the control signal is smaller than the second duty cycle; a duty cycle of the control signal ranges between the first duty cycle and the second duty cycle; and the first preset angle is a conduction angle corresponding to a state when the SCR dimmer is adjusted to turn off an SCR lamp.

17. The driving circuit according to claim 16, wherein the control signal comprises a first control signal, and
the wireless control module is configured to:
generate the first control signal in response to the gesture operation adjustment instruction when the conduction angle data of the SCR dimmer remain unchanged; wherein when a current conduction angle data of the SCR dimmer corresponds to a first target duty cycle of the control signal, a duty cycle of the first control signal ranges between the first duty cycle and the first target duty cycle; and the first target duty cycle is smaller than or equal to the second duty cycle.

18. The driving circuit according to claim 16, wherein the control signal comprises a second control signal, and
the wireless control module is configured to:
generate the second control signal when the conduction angle data of the SCR dimmer is adjusted from a first conduction angle to a second conduction angle; wherein the first conduction angle of the SCR dimmer corresponds to a second target duty cycle of the control signal, the second conduction angle of the SCR dimmer corresponds to a third target duty cycle of the control signal; and a duty cycle of the second control signal is adjusted back to the second target duty cycle from a current duty cycle first, and then adjusted to the third target duty cycle from the second target duty cycle.

19. The driving circuit according to claim 16, wherein
the wireless control module is configured to:
match the first preset angle of the conduction angle data with the first duty cycle of the control signal, and match a current conduction angle data of the SCR dimmer with the second duty cycle of the control signal, when a duty cycle adjustment range of the SCR dimmer remains unchanged;
wherein a second duty cycle of an actual output of the control signal is a product of the current conduction angle data of the SCR dimmer and a brightness ratio of the SCR lamp; and the brightness ratio of the SCR lamp is a ratio of the current conduction angle data of the SCR dimmer to a conduction angle corresponding to a maximum brightness of the SCR lamp.

20. The driving circuit according to claim 15, further comprising:
a passive bleeder circuit, connected between the SCR dimmer and the angle detection module and configured to provide a remaining current for the SCR dimmer.

21. The driving circuit according to claim 15, wherein the power adjustment module comprises:
a rectifier unit, connected with the SCR dimmer and configured to rectify an AC power signal transmitted from the SCR dimmer into a DC power signal;
a DC-DC voltage stabilizer unit, connected with the rectifier unit and configured to increase a voltage of the DC power signal and output a stable first power signal;
a DC-DC linear dimming unit, connected with the DC-DC voltage stabilizer unit and an SCR lamp and configured to receive the first power signal and generate a driving signal according to the control signal; and
a modular power supply unit, connected with the DC-DC voltage stabilizer unit and the wireless control module and configured to decrease a voltage of the first power signal and supply power to the wireless control module.

22. The driving circuit according to claim 15, wherein
a communication mode of the wireless control module comprises at least one of the followings: WIFI, Zigbee, Bluetooth, and Thread.

23. A driving method compatible with SCR and wireless dimming, comprising:
acquiring, by an angle detection module, conduction angle data of an SCR dimmer;
generating a control signal in response to a gesture operation adjustment instruction according to the conduction angle data of the SCR dimmer; and
outputting the control signal to a power adjustment module to adjust a driving signal output from the power adjustment module.

24. The method according to claim 23, before generating a control signal in response to a gesture operation adjustment instruction according to the conduction angle data of the SCR dimmer, further comprising:
matching a first preset angle of the conduction angle data with a first duty cycle of the control signal; and
matching a second preset angle of the conduction angle data with a second duty cycle of the control signal;
wherein the first preset angle is smaller than the second preset angle, the first duty cycle of the control signal is smaller than the second duty cycle, and a duty cycle of the control signal ranges between the first duty cycle and the second duty cycle.

25. The method according to claim 24, wherein generating a control signal in response to a gesture operation adjustment instruction according to the conduction angle data of the SCR dimmer comprises:
matching the first preset angle of the conduction angle data with the first duty cycle of the control signal, and matching the second preset angle of the conduction angle data with the second duty cycle of the control signal;
wherein the first preset angle is smaller than the second preset angle, and the first duty cycle of the control signal is smaller than the second duty cycle; a duty cycle of the control signal ranges between the first duty cycle and the second duty cycle; and the first preset angle is a conduction angle corresponding to a state when the SCR dimmer is adjusted to turn off an SCR lamp.

26. The method according to claim 24, wherein generating a control signal in response to a gesture operation adjustment instruction according to the conduction angle data of the SCR dimmer further comprises:
generating a first control signal of the control signal in response to the gesture operation adjustment instruction when the conduction angle data of the SCR dimmer remains unchanged, wherein when a current conduction angle data of the SCR dimmer corresponds to a first target duty cycle of the control signal, a duty cycle of the first control signal ranges between the first duty cycle and the first target duty cycle, and the first target duty cycle is smaller than or equal to the second duty cycle;
generating a second control signal of the control signal when the conduction angle data of the SCR dimmer is adjusted from a first conduction angle to a second conduction angle, wherein the first conduction angle of the SCR dimmer corresponds to a second target duty cycle of the control signal, the second conduction angle of the SCR dimmer corresponds to a third target duty cycle of the control signal, and a duty cycle of the second control signal is adjusted back to the second target duty cycle from a current duty cycle first, and then adjusted to the third target duty cycle from the second target duty cycle; and
matching the first preset angle of the conduction angle data with the first duty cycle of the control signal, and matching the current conduction angle data of the SCR dimmer with the second duty cycle of the control signal, when a duty cycle adjustment range of the SCR dimmer remains unchanged, wherein a second duty cycle of an actual output of the control signal is a product of the current conduction angle data of the SCR dimmer and a brightness ratio of the SCR lamp, and the brightness ratio of the SCR lamp is a ratio of the current conduction angle data of the SCR dimmer to a conduction angle corresponding to a maximum brightness of the SCR lamp.

27. An SCR lamp, comprising the driving circuit compatible with SCR and wireless dimming according to claim 15, and a lamp bead;
wherein the driving circuit compatible with SCR and wireless dimming is configured to execute the driving method compatible with SCR and wireless dimming comprising:
acquiring, by an angle detection module, conduction angle data of an SCR dimmer;
generating a control signal in response to a gesture operation adjustment instruction according to the conduction angle data of the SCR dimmer; and
outputting the control signal to a power adjustment module to adjust a driving signal output from the power adjustment module; and
the driving circuit compatible with SCR and wireless dimming is connected with the lamp bead and configured to output a driving signal to the lamp bead.
